(19) United States
(12) Patent Application Publication
(10) Pub. No.: US 2025/0210032 A1
(43) Pub. Date: Jun. 26, 2025

(54) HEARING ASSISTANCE DEVICE, HEARING ASSISTANCE METHOD, AND COMPUTER-READABLE RECORDING MEDIUM

(71) Applicant: NEC Corporation, Minato-ku, Tokyo (JP)

(72) Inventors: Daichi NISHII, Tokyo (JP); Akira GOTOH, Tokyo (JP); Shuji KOMEIJI, Tokyo (JP); Yuko NAKANISHI, Tokyo (JP); Yuka ENJOJI, Tokyo (JP)

(73) Assignee: NEC Corporation, Minato-ku, Tokyo (JP)

(21) Appl. No.: 18/846,719

(22) PCT Filed: Mar. 22, 2022
(86) PCT No.: PCT/JP2022/013053

§ 371 Date: Sep. 13, 2024

(51) Int. Cl. G10L 15/05; G10L 15/22

(52) U.S. Cl. CPC G10L 15/05; G10L 15/22; G10L 2015/221

(57) ABSTRACT

a hearing assistance apparatus includes: a speech recognition information generation unit executes speech recognition processing on first speech information to infer one or more words from the first speech information, and generating speech recognition information by, for each of the one or more inferred words, associating word information representing the inferred word with second speech information corresponding to the inferred word; a first division unit divides a first character string formed by the one or more words into individual words or individual characters using the word information to generate second character string information representing a second character string; and a display information generation unit generates display information for displaying, on a display device, the second character string and a division position indicating a position at which the first character string was divided.

### TECHNICAL FIELD

The technical field relates to a hearing assistance apparatus and a hearing assistance method for assisting hearing, and further relates to a computer readable recording medium having recorded thereon a program for implementing the same.

### BACKGROUND ART

The speech recognition apparatus disclosed in Patent Document 1 first executes speech recognition processing on input speech information and infers a plurality of words from the speech information. Next, when speech is reproduced by a user, the speech recognition apparatus of Patent Document 1 causes a display device to display the inferred words that correspond to the reproduced portion of the speech in a highlighted manner.

### LIST OF RELATED ART DOCUMENTS

### Patent Document

Patent Document 1: Japanese Patent Laid-Open Publication No. 2003-518266

### SUMMARY OF INVENTION

### Problems to be Solved by the Invention

However, with the speech recognition apparatus of Patent Document 1, in the case where the user desires to listen to a portion of speech, the user needs to manually search for the portion of the speech that corresponds to the desired portion. In other words, the user needs to listen to portions that the user does not desire to listen to, thus requiring a long listening time.

An object of the present invention is to provide a hearing assistance apparatus, a hearing assistance method, and a computer readable recording medium that reduce the listening time by presenting a desired portion of speech to the user when the user listens to speech.

### Means for Solving the Problems

In order to achieve the example object described above, a hearing assistance apparatus according to an example aspect includes:
a speech recognition information generation unit executes speech recognition processing on first speech information to infer one or more words from the first speech information, and generating speech recognition information by, for each of the one or more inferred words, associating word information representing the inferred word with second speech information corresponding to the inferred word;
a first division unit divides a first character string formed by the one or more words into individual words or individual characters using the word information to generate second character string information representing a second character string; and
a display information generation unit generates display information for displaying, on a display device, the second character string and a division position indicating a position at which the first character string was divided.

Also, in order to achieve the example object described above, a hearing assistance method that is performed by a computer according to an example aspect includes:
executing speech recognition processing on first speech information to infer one or more words from the first speech information, and generating speech recognition information by, for each of the one or more inferred words, associating word information representing the inferred word with second speech information corresponding to the inferred word;
dividing a first character string formed by the one or more words into individual words or individual characters using the word information to generate second character string information representing a second character string; and
generating display information for displaying, on a display device, the second character string and a division position indicating a position at which the first character string was divided.

Furthermore, in order to achieve the example object described above, a computer-readable recording medium according to an example aspect includes a program recorded on the computer-readable recording medium, the program including instructions that cause the computer to carry out:
executing speech recognition processing on first speech information to infer one or more words from the first speech information, and generating speech recognition information by, for each of the one or more inferred words, associating word information representing the inferred word with second speech information corresponding to the inferred word;
dividing a first character string formed by the one or more words into individual words or individual characters using the word information to generate second character string information representing a second character string; and
generating display information for displaying, on a display device, the second character string and a division position indicating a position at which the first character string was divided.

### Advantageous Effects of the Invention

According to an aspect, it is possible to reduce the listening time by presenting a desired portion of speech to the user when the user listens to speech.

### BRIEF DESCRIPTION OF THE DRAWINGS

FIG. 1 is a diagram illustrating an example of a hearing assistance apparatus.

FIG. 2 is a diagram illustrating an example of a system that includes the hearing assistance apparatus.

FIG. 3 is a diagram illustrating an example of the data structure of the speech recognition information.

FIG. 4 is a diagram illustrating an example of the normal image.

FIG. 5 is a diagram for describing an example of the character image.

FIG. 6 is a diagram for describing an example of the word image.

FIG. 7 is a diagram for describing an example of the join image.

FIG. 8 is a diagram for describing an example of the normal image.

FIG. 9 is a diagram for describing an example of the join image.

FIG. 10 is a diagram for describing an example of the confidence image.

FIG. 11 is a diagram illustrating an example of the attention image.

FIG. 12 is a diagram illustrating an example of operation of the hearing assistance apparatus.

FIG. 13 is a diagram for describing the first variation.

FIG. 14 is a diagram for describing an example of a computer that realizes the hearing assistance apparatus in the first example embodiment and the first variation.

### EXAMPLE EMBODIMENTS

Hereinafter, example embodiments will be described with reference to the drawings. Note that in the drawings described below, elements having the same or corresponding functions are denoted by the same reference numerals, and repeated description thereof may be omitted.

### First Example Embodiment

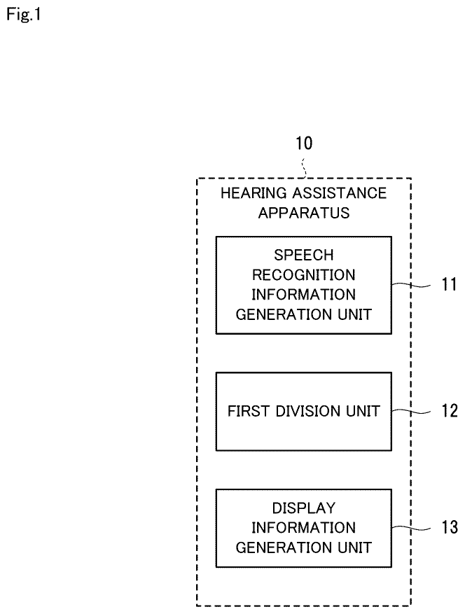

The configuration of a hearing assistance apparatus 10 according to a first example embodiment will be described below with reference to FIG. 1. FIG. 1 is a diagram illustrating an example of a hearing assistance apparatus.

### Apparatus Configuration

The hearing assistance apparatus 10 is an apparatus that presents a desired portion of speech to a user when the user desires to re-listen to a portion that the user was unable to hear. As shown in FIG. 1, the hearing assistance apparatus 10 includes a speech recognition information generation unit 11, a first division unit 12, and a display information generation unit 13.

The speech recognition information generation unit 11 executes speech recognition processing on first speech information to infer one or more words from the first speech information, and generates speech recognition information by, for each inferred word, associating word information representing the inferred word with second speech information corresponding to the inferred word.

The first speech information is information that represents an utterance (first speech) uttered by a person attending a conference, a person making a call using a communication device, or the like. The first speech information is information generated based on speech picked up using a microphone or the like. The first speech information may be speech waveform data, for example.

The second speech information is information representing speech (second speech) that corresponds to words inferred from the first speech information.

The speech recognition processing uses a technique such as ASR (Automatic Speech Recognition) to infer one or more words from speech information and generate word information that corresponds to the one or more inferred words.

The first division unit 12 divides a first character string formed by one or more words into individual words or individual characters using word information to generate second character string information representing a second character string.

The display information generation unit 13 generates display information for displaying, on a display device, the second character string and division positions indicating positions at which the first character string was divided.

In this way, in the first example embodiment, by displaying the division positions at which the first character string was divided on the display device, it is possible to present a portion that the user desires to listen to, thereby eliminating the need for the user to search for the desired portion. Accordingly, it is possible to reduce the time that the user spends listening to speech.

### System Configuration

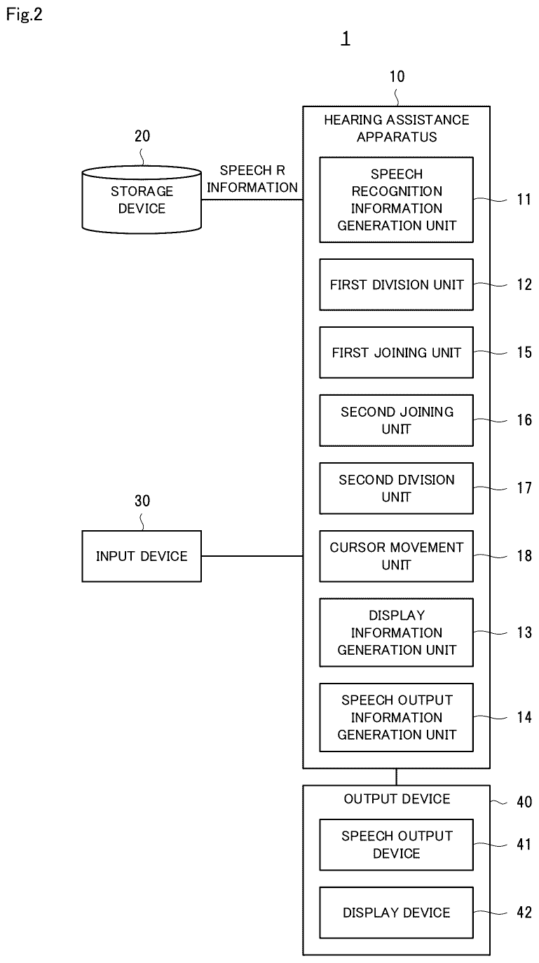

The configuration of the hearing assistance apparatus 10 in the first example embodiment will be described in more detail below with reference to FIG. 2. FIG. 2 is a diagram illustrating an example of a system that includes the hearing assistance apparatus.

The system 1 includes the hearing assistance apparatus 10, a storage device 20, an input device 30, and an output device 40.

The hearing assistance apparatus 10 includes the speech recognition information generation unit 11, the first division unit 12, a first joining unit 15, a second joining unit 16, a second division unit 17, a cursor movement unit 18, the display information generation unit 13, and a speech output information generation unit 14.

The hearing assistance apparatus 10 is an information processing device such as a CPU (Central Processing Unit), a programmable device (e.g., an FPGA (Field-Programmable Gate Array)), a GPU (Graphics Processing Unit), a circuit equipped with any one or more of the aforementioned, a server computer, a personal computer, or a mobile terminal, for example.

The storage device 20 is a device that stores at least speech information. The storage device 20 may be a database, a server computer, a circuit that has a memory, or the like.

In the example of FIG. 2, the storage device 20 is provided outside the hearing assistance apparatus 10, but it may also be provided inside the hearing assistance apparatus 10.

The input device 30 is a mouse, a keyboard, or a touch panel, for example. The input device 30 is used to, for example, operate the hearing assistance apparatus 10, the output device 40, or both.

The output device 40 includes a speech output device 41 that acquires speech output information and outputs speech, and a display device 42 that acquires display information and displays images, for example.

The speech output device 41 is a device that outputs speech, such as a speaker. The display device 42 is a device for displaying images, such as a liquid crystal display, an organic EL (Electro Luminescence) display, or a CRT (Cathode Ray Tube), for example. Note that the output device 40 may be a printing device such as a printer.

The hearing assistance apparatus will be described in detail below.

The hearing assistance apparatus 10 displays the following images on the display device 42. A normal image (1), a character image (2), a word image (3), a join image (4-1, 4-2), a confidence image (5), and an attention image (6) are presented to the user.

### (1) Normal Image

The normal image is an image for displaying one or more first character strings for each speaker. The normal image is generated as follows.

First, the speech recognition information generation unit 11 acquires first speech information stored (recorded) in the storage device 20. Alternatively, the speech recognition information generation unit 11 acquires, in real time, first speech information that corresponds to first speech input via a microphone or the like.

Next, the speech recognition information generation unit 11 executes speech recognition processing on the acquired first speech information, and infers one or more words from the first speech information.

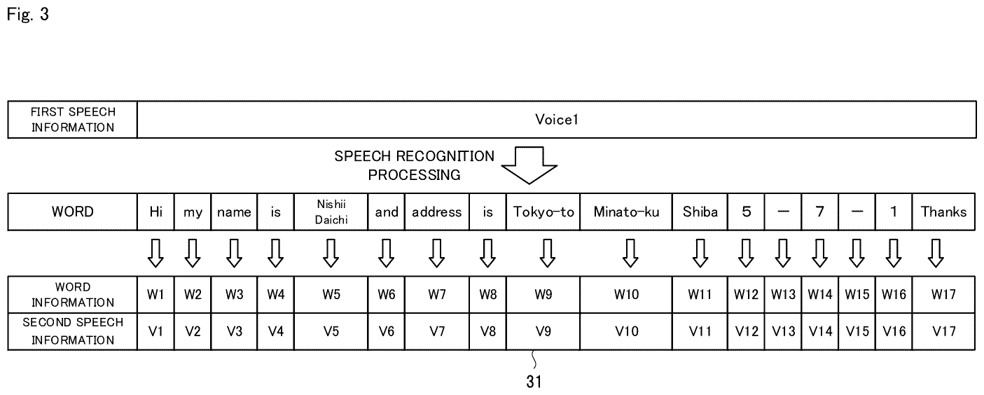

FIG. 3 is a diagram illustrating an example of the data structure of the speech recognition information. In the example of FIG. 3, first speech information Voice1 is acquired, speech recognition processing is executed on the first speech information Voice1, and a plurality of words are inferred.

For example, in the case where the first speech is “Hi, my name is Nishii Daichi and address is Tokyo-to, Minato-ku, Shiba 5-7-1. Thanks.” which is uttered by the user, the words that are inferred from first speech information corresponding to that first speech are “Hi”, “my”, “name”, “is”, “Nishii Daichi”, “and”, “address”, “is”, “Tokyo-to”, “Minato-ku”, “Shiba”, “5”, “-”, “7”, “-”, “1”, and “Thanks”.

Next, the speech recognition information generation unit 11 generates speech recognition information 31 by, for each inferred word, associating word information corresponding to the inferred word with speech information. Thereafter, the speech recognition information generation unit 11 stores the generated speech recognition information 31 in a memory such as the storage device 20, for example.

In the example of FIG. 3, the speech recognition information generation unit 11 generates speech recognition information 31 by, for each inferred word, associating a piece of word information (W1 to W17) corresponding to the inferred word with a piece of second speech information (V1 to V17). For example, in the case of the word “Hi”, word information “W1” that corresponds to the word “Hi” is associated with the second speech information “V1”.

Next, the display information generation unit 13 generates display information for causing the display device 42 to display an image corresponding to the first character string (a character string formed by one or more words). Next, the display information generation unit 13 outputs the generated display information to the display device 42.

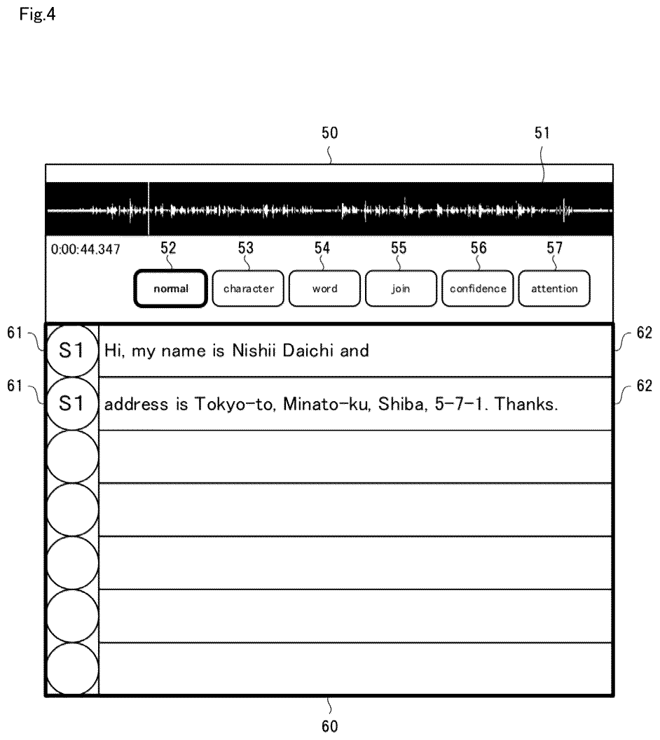

FIG. 4 is a diagram illustrating an example of the normal image. In the example of FIG. 4, a normal image 60 is displayed on a graphical user interface 50 used for hearing assistance.

The graphical user interface 50 in FIG. 4 displays a speech waveform display region 51, a button 52 (normal), a button 53 (character), a button 54 (word), a button 55 (join), a button 56 (confidence), a button 57 (attention), and the normal image 60, for example.

The speech waveform display region 51 displays a speech waveform image generated based on the first speech information. However, the graphical user interface 50 does not necessarily need to include the speech waveform display region 51.

The button 52 is a button that, when selected (e.g., clicked) by a user, causes the graphical user interface 50 to display the normal image 60. In the example of FIG. 4, the button 52 has been selected (bold line), and the normal image 60 is being displayed by the graphical user interface 50.

Speaker identification display regions 61 (S1) and character string display regions 62 for displaying character strings corresponding to the speaker identification display regions 61 are displayed in the normal image 60. In the example of FIG. 4, the first character strings “Hi, my name is Nishii Daichi and” and “address is Tokyo-to, Minato-ku, Shiba, 5-7-1. Thanks.”, which correspond to first speech uttered by a speaker S1, are displayed in corresponding character string display regions 62.

As shown in FIG. 4, portions of one first character string corresponding to the same speaker S1 may be displayed in different character string display regions 62. The criteria for dividing a first character string may be division by a predetermined number of characters, or division at inferred positions that correspond to phrases or sentences, for example.

### (2) Character Image

The character image is an image for displaying a second character string obtained by dividing a first character string into individual characters for each speaker. The character image is generated as follows.

First, upon receiving notification of an instruction to display a character image, the first division unit 12 divides the first character string “Hi, my name is Nishii Daichi and” into individual characters to obtain second character string information representing the second character string “H” “i” “M” “y” “n” “a” “m” “e” “i” “s” “N” “i” “s” “h” “i” “i” “D” “a” “i” “c” “h” “i” “a” “n” “d”, and divides the first character string “address is Tokyo-to, Minato-ku, Shiba, 5-7-1. Thanks.”

into individual characters to obtain second character string information representing the second character string “a” “d” “d” “r” “e” “s” “s” “i” “s” “T” “o” “k” “y” “o” “-” “t” “o” “M” “i” “n” “a” “t” “o” “-” “k” “u” “S” “h” “i” “b” “a” “5” “-” “7” “-” “1” “T” “h” “a” “n” “k “s”, for example.

For example, in the processing for division into individual characters, the speech recognition information generation unit 11 generates character information by using the pieces of word information (W1 to W17) to further divide a divisible word into individual characters. The speech recognition information generation unit 11 also generates third speech information by dividing the pieces of second speech information (V1 to V17) in accordance with the divided characters. Then, speech recognition information for character division, in which the pieces of character information corresponding to the divided characters are associated one-to-one with the divided pieces of third speech information, is generated.

Next, the display information generation unit 13 generates display information for displaying, on the display device 42, the first character strings and division positions indicating positions at which the first character strings were divided. Next, the display information generation unit 13 outputs the generated display information to the display device 42.

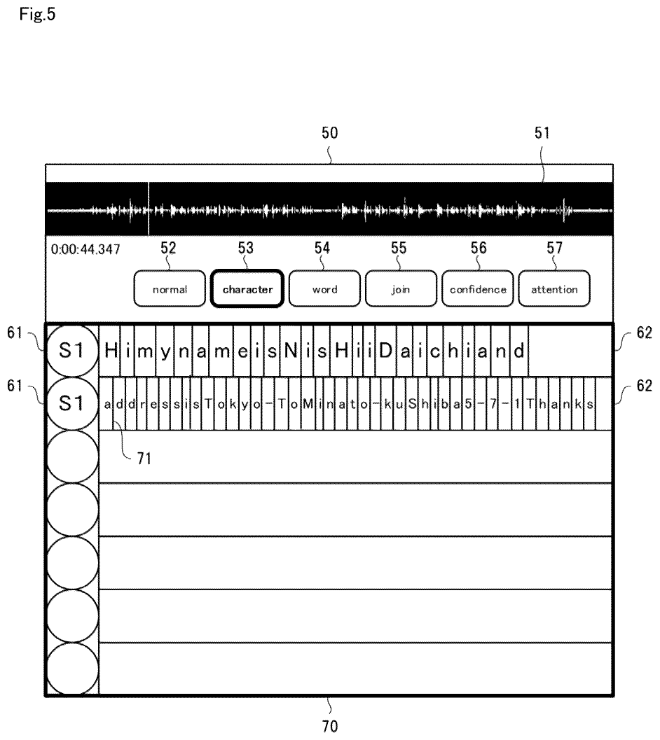

FIG. 5 is a diagram for describing an example of the character image. In the example of FIG. 5, a character image 70 is displayed on the graphical user interface 50 used for hearing assistance.

The graphical user interface 50 in FIG. 5 displays the speech waveform display region 51, the button 52 (normal), the button 53 (character), the button 54 (word), the button 55 (join), the button 56 (confidence), the button 57 (attention), and the character image 70, for example.

The button 53 is a button that, when selected (e.g., clicked) by a user, causes the graphical user interface 50 to display the character image 70. In the example of FIG. 5, the button 53 has been selected (bold line), and the character image 70 is being displayed by the graphical user interface 50.

The character image 70 includes the speaker identification display regions 61 (S1) and the character string display regions 62. FIG. 5 shows an example in which the upper first character string “Hi, my name is Nishii Daichi and” displayed in the upper character string display region 62 in FIG. 4 has been divided into individual characters to generate the upper second character string “H” “i” “m” “y” “n” “a” “m” “e” “i” “s” “N” “i” “s” “h” “i” “i” “D” “a” “i” “c” “h” “i” “a” “n” “d” displayed in the upper character string display region 62 in FIG. 5, and the lower first character string “address is Tokyo-to, Minato-ku, Shiba, 5-7-1. Thanks.” displayed in the lower character string display region 62 in FIG. 4 has been divided into individual characters to generate the lower second character string “a” “d” “d” “r” “e” “s” “s” “i” “s” “T” “o” “k” “y” “o” “-” “t” “o” “M” “i” “n” “a” “t” “o” “-” “k” “u” “S” “h” “i” “b” “a” “5” “-” “7” “-” “1” “T” “h” “a” “n” “k “s” displayed in the lower character string display region 62 in FIG. 5.

The division positions are displayed between each of the characters. In the example of FIG. 5, an indication 71 (vertical solid line) indicating a division position is displayed between “a” and “d” (between the characters) in the second character string. Note that the other division positions will not be described.

### (3) Word Image

The word image is an image for displaying a second character string acquired by dividing a first character string into individual words for each speaker. The word image is generated as follows.

First, upon receiving notification of an instruction to display a word image, the first division unit 12 divides the first character string “Hi, my name is Nishii Daichi and” into individual words to obtain second character string information representing the second character string “Hi” “my” “name” “is” “Nishii” “Daichi” “and”, and divides the first character string “address is Tokyo-to, Minato-ku, Shiba, 5-7-1. Thanks.” into individual words to obtain second character string information representing the second character string “address” “is” “Tokyo-to” “Minato-ku” “Shiba” “5” “-” “7” “-” “1” “Thanks”, for example.

Next, the display information generation unit 13 generates display information for displaying, on the display device 42, the first character strings and division positions indicating positions at which the first character strings were divided. Next, the display information generation unit 13 outputs the generated display information to the display device 42.

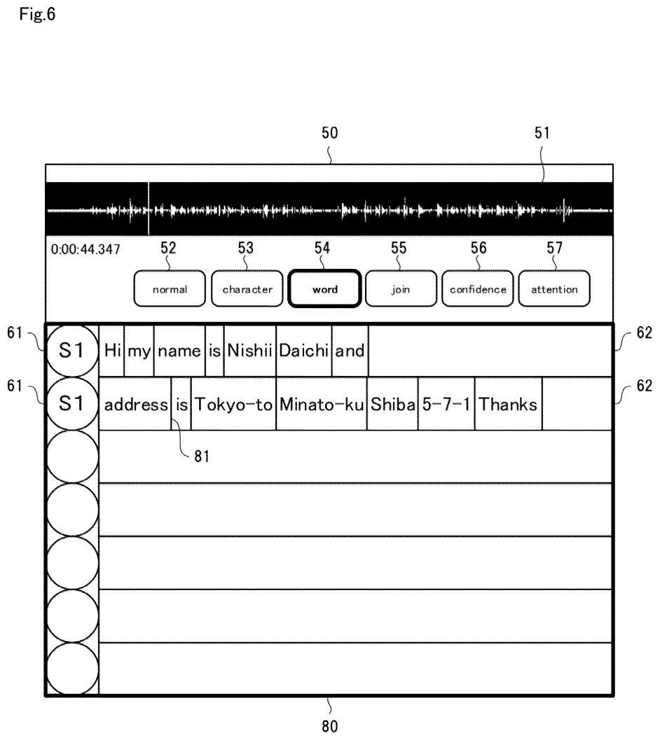

FIG. 6 is a diagram for describing an example of the word image. In the example of FIG. 6, a word image 80 is displayed on the graphical user interface 50 used for hearing assistance.

The graphical user interface 50 in FIG. 6 displays the speech waveform display region 51, the button 52 (normal), the button 53 (character), the button 54 (word), the button 55 (join), the button 56 (confidence), the button 57 (attention), and the word image 80, for example.

The button 54 is a button that, when selected (e.g., clicked) by a user, causes the graphical user interface 50 to display the word image 80. In the example of FIG. 6, the button 54 has been selected (bold line) and the word image 80 is being displayed by the graphical user interface 50.

The word image 80 includes the speaker identification display regions 61 (S1) and the character string display regions 62. FIG. 6 shows an example in which the upper first character string “Hi, my name is Nishii Daichi and” displayed in the upper character string display region 62 in FIG. 4 has been divided into individual words to generate the upper second character string “Hi” “my” “name” “is” “Nishii” “Daichi” “and” corresponding to the upper first character string and displayed in the upper character string display region 62 in FIG. 6, and the lower first character string “address is Tokyo-to, Minato-ku, Shiba, 5-7-1. Thanks.” displayed in the lower character string display region 62 in FIG. 4 has been divided into individual characters to generate the lower second character string “address” “is” “Tokyo-to” “Minato-ku” “Shiba” “5” “-” “7” “-” “1” “Thanks” corresponding to the lower first character string and displayed in the lower character string display region 62 in FIG. 6.

The division positions are displayed between each of the words. In the example of FIG. 6, an indication 81 (vertical solid line) indicating a division position is displayed between “address” and “is” (between the words) in the second character string. The other division positions will not be described.

### (4-1) Join Image

The join image is an image for displaying a character string obtained by joining first character strings corresponding to the same speaker. The join image is generated as follows.

First, upon receiving notification of an instruction to display a join image, if first character strings that correspond to speech uttered by the same speaker are displayed consecutively, the first joining unit 15 joins the consecutive first character strings corresponding to the same speaker in the order of utterance.

For example, as shown in FIG. 4, when the first character strings “Hi, my name is Nishii Daichi and” and “address is Tokyo-to, Minato-ku, Shiba, 5-7-1. Thanks.” are displayed in the two character string display regions 62 corresponding to the speaker S1, the two first character strings are joined to generate character string information representing the character string “Hi, my name is Nishii Daichi and address is Tokyo-to, Minato-ku, Shiba, 5-7-1. Thanks.”

Next, the display information generation unit 13 generates display information for displaying, on the display device 42, the character string formed by joining the first character strings. Next, the display information generation unit 13 outputs the generated display information to the display device 42.

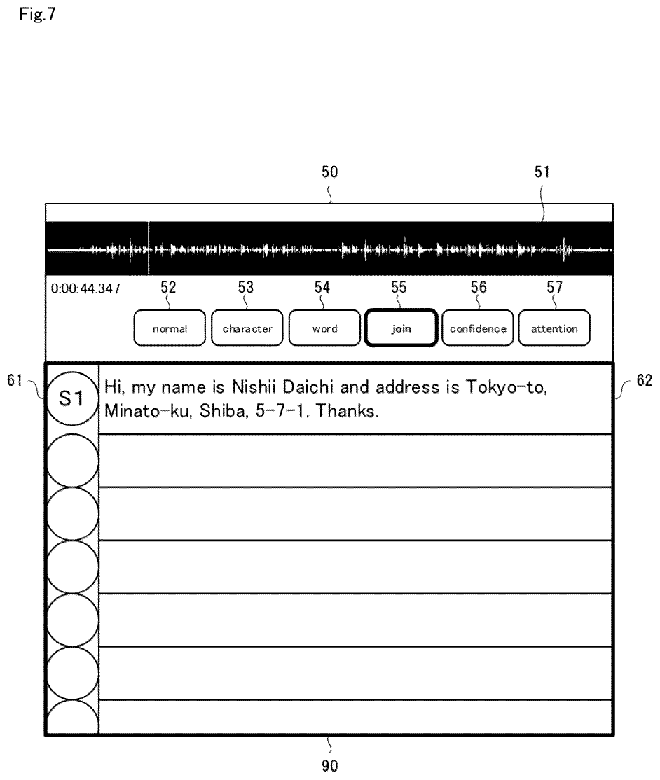

FIG. 7 is a diagram for describing an example of the join image. In the example of FIG. 7, a join image is displayed on the graphical user interface 50 used for hearing assistance.

The graphical user interface 50 in FIG. 7 displays the speech waveform display region 51, the button 52 (normal), the button 53 (character), the button 54 (word), the button 55 (join), the button 56 (confidence), the button 57 (attention), and a join image 90, for example.

The button 55 is a button that, when selected (e.g., clicked) by a user, causes the graphical user interface 50 to display the join image 90. In the example of FIG. 7, the button 55 has been selected (bold line), and the word image 80 is being displayed by the graphical user interface 50.

The join image 90 includes the speaker identification display regions 61 (S1) and the character string display regions 62. In the example of FIG. 7, the first character strings “Hi, my name is Nishii Daichi and” and “address is Tokyo-to, Minato-ku, Shiba, 5-7-1. Thanks.” displayed in the character string display regions 62 of FIG. 4 are joined to generate the character string “Hi, my name is Nishii Daichi and address is Tokyo-to, Minato-ku, Shiba, 5-7-1. Thanks.”, which is displayed in the character string display region 62 of FIG. 7.

### (4-2) Join Image

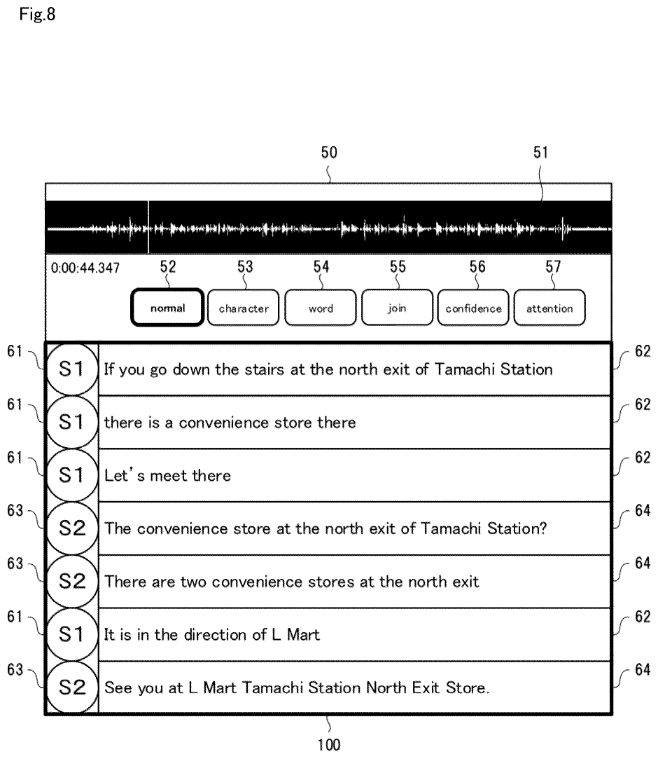

FIG. 8 is a diagram for describing an example of the normal image. The graphical user interface 50 in FIG. 8 displays the speech waveform display region 51, the button 52 (normal), the button 53 (character), the button 54 (word), the button 55 (join), the button 56 (confidence), the button 57 (attention), and a normal image 100, for example.

In the normal image 100 shown in FIG. 8, the character strings “If you go down the stairs at the north exit of Tamachi Station”, “there is a convenience store there”, and “Let's meet there” are respectively displayed in character string display regions 62 corresponding to speaker identification display regions 61 (S1) in the stated order from the top.

Below that, the character strings “The convenience store at the north exit of Tamachi Station?” and “There are two convenience stores at the north exit” are displayed in character string display regions 64 corresponding to speaker identification display regions 63 (S2).

In this manner, if a user selects (e.g., clicks) the button 55 while first character strings corresponding to speech uttered by the same speaker S1 or S2 are displayed consecutively as shown in FIG. 8, an instruction to display a join image is transmitted to the first joining unit 15.

When the first joining unit 15 receives the notification, the first joining unit 15 joins consecutive first character strings that correspond to the same speaker in the order in which the utterances were made, and generates character string information representing the joined character strings.

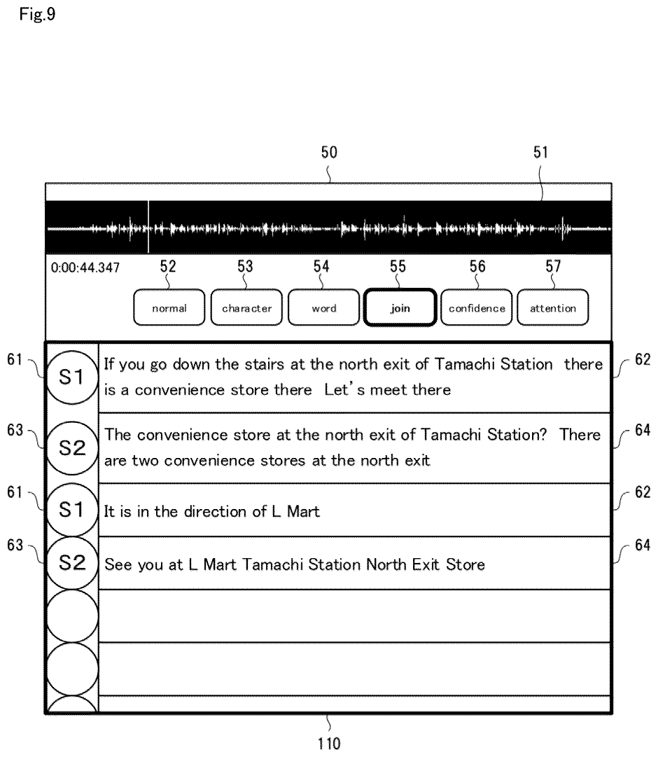

Next, the display information generation unit 13 generates display information for displaying a join image 110 as shown in FIG. 9 on the display device 42. Next, the display information generation unit 13 outputs the generated display information to the display device 42.

FIG. 9 is a diagram for describing an example of the join image. The graphical user interface 50 in FIG. 9 displays the speech waveform display region 51, the button 52 (normal), the button 53 (character), the button 54 (word), the button 55 (join), the button 56 (confidence), the button 57 (attention), and a join image 110, for example.

In the join image 110 shown in FIG. 9, the character string “If you go down the stairs at the north exit of Tamachi Station there is a convenience store there Let's meet there” is displayed in the character string display region 62 corresponding to the speaker identification display region 61 (S1) in the stated order from the top.

Below that, the character string “The convenience store at the north exit of Tamachi Station? There are two convenience stores at the north exit” is displayed in the character string display region 64 corresponding to the speaker identification display region 63 (S2).

### (5) Confidence Image

The confidence image is an image for displaying a character string formed by joining first character strings corresponding to the same speaker based on confidence levels associated with words included in the first character strings. The confidence image is generated as follows.

First, each of the words in the first character string is associated with a confidence level, and, upon receiving an instruction to display a confidence image, the second joining unit 16 detects a word associated with a confidence level greater than or equal to a pre-set confidence threshold (a high-confidence word) in the first character string, and if a plurality of detected words are consecutive, joins the consecutive detected words in the order of utterance.

The confidence level is generated using a general technique in the processing of inferring one or more words from the first speech information described above. The confidence level is associated with the word information. The confidence level is an index that indicates how reliable the inferred word is. The confidence threshold is determined by experimentation or simulation, for example.

Next, the display information generation unit 13 generates display information for displaying, on the display device 42, a character string formed by joining consecutive high-confidence words in the order of utterance, low-confidence words, an indication of the position of the joined character string, and the division positions of low-confidence words. Next, the display information generation unit 13 outputs the generated display information to the display device 42.

For example, in the case where the first character string “Hi, my name is nishi no daichi and” is displayed in the character string display region 62 corresponding to the speaker S1 in the normal image, if the confidence level of the words “my”, “name”, and “is” is high and the confidence level of the other words “nishi no daichi” and “and” is low; the high-confidence words are joined in the order of utterance to generate the character string “my name is”. Also, the low-confidence words “nishi no daichi” and “and”, are left as they are.

Next, in the case where the first character string “address is Tokyo-to, Minato-ku, Shiba, 5-7-1. Thanks.” is displayed in the character string display region 62 corresponding to the speaker S1 in the normal image, if the confidence level of the words “address” and “is” is high and the confidence of the other words “Tokyo-to”, “Minato-ku”, “Shiba”, “5”, “7” , “-”, and “1” is low. the high-confidence words are joined in the order of utterance to generate the character string “address is”. Also, the low-confidence words “Tokyo-to”, “Minato-ku”, “Shiba”, “5”, “-”, “7”,“-”, and “1”, are left as they are.

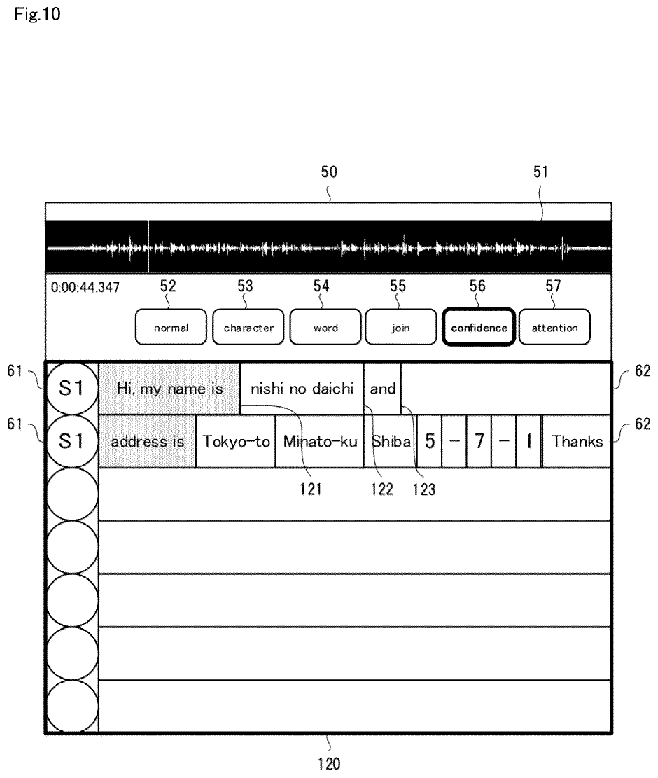

FIG. 10 is a diagram for describing an example of the confidence image. In the example of FIG. 10, a confidence image 120 is displayed on the graphical user interface 50 used for hearing assistance.

The graphical user interface 50 in FIG. 10 displays the speech waveform display region 51, the button 52 (normal), the button 53 (character), the button 54 (word), the button 55 (join), the button 56 (confidence), the button 57 (attention), and the confidence image 120, for example. The button 56 is a button that, when selected (e.g., clicked) by a user, causes the graphical user interface 50 to display the confidence image 120. In the example of FIG. 10, the button 56 has been selected (bold line), and the confidence image 120 is being displayed by the graphical user interface 50.

The confidence image 120 includes the speaker identification display regions 61 (S1) and the character string display regions 62. In the example of FIG. 10, based on the first character strings “Hi, my name is nishi no daichi and” and “address is Tokyo-to, Minato-ku, Shiba, 5-7-1. Thanks.” displayed in the character string display regions 62 of FIG. 4, the high-confidence words are joined in the order of utterance to generate the character string “Hi, my name is”, which is displayed together with the low-confidence words “nishi no daichi” and “and” in the upper character string display region 62 in FIG. 10.

Also, an indication 121 (vertical solid line) indicating the position of the joined character string, and division positions 123 and 124 (vertical solid lines) of low-confidence words are displayed in the upper character string display region 62 in FIG. 10. Furthermore, the joined character string may be highlighted, or the color, the pattern, or the like of the area surrounding the joined character string may be changed.

Conversely; the low-confidence words may be highlighted, or the color, the pattern, or the like of the area surrounding the joined character string may be changed.

Note that since the upper character string display region 62 in FIG. 10 has already been described, a description of the lower character string display region 62 in FIG. 10 will be omitted.

### (6) Attention Image

The attention image is an image for displaying a third character string acquired by dividing a first character string according to the number of times the user has listened to the corresponding speech. The attention image is generated as follows.

First, after receiving an instruction to display an attention image, if the user listens to speech corresponding to a target first character string, and furthermore a listening count indicating how many times the user has listened to speech corresponding to the target first character string is a pre-set listening count threshold or more, the second division unit 17 divides the first character string to generate a plurality of third character strings.

The listening count is a value that is incremented each time speech corresponding to the target first character string is listened to, and is stored in a memory. The listening count threshold is determined by experimentation, simulation, or the like.

Next, the display information generation unit 13 generates display information for displaying, on the display device 42, the first character strings and division positions indicating positions at which the first character strings were divided. Next, the display information generation unit 13 outputs the generated display information to the display device 42.

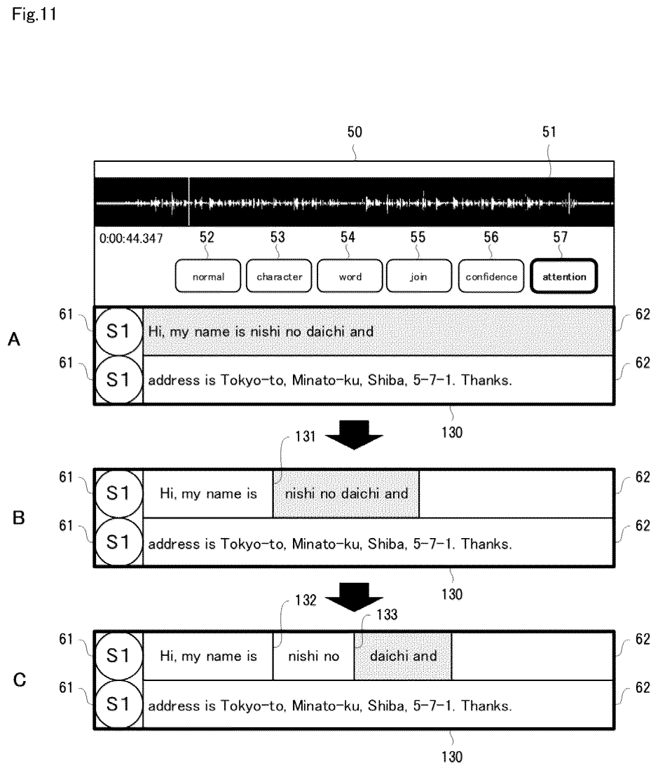

FIG. 11 is a diagram illustrating an example of the attention image. In the example of FIG. 11, an attention image 130 is displayed on a graphical user interface 50 used for hearing assistance.

The graphical user interface 50 in FIG. 11 displays the speech waveform display region 51, the button 52 (normal), the button 53 (character), the button 54 (word), the button 55 (join), the button 56 (confidence), the button 57 (attention), and the attention image 130, for example.

The button 57 is a button that, when selected (e.g., clicked) by a user, causes the graphical user interface 50 to display the attention image 130. In the example of FIG. 11, the button 57 has been selected (bold line), and the attention image 130 is being displayed by the graphical user interface 50.

For example, in the case where the target first character string “Hi, my name is nishi no daichi and” is displayed in the character string display region 62 corresponding to the speaker S1 shown in section A in FIG. 11, if the user selects (e.g., clicks) the upper speaker identification display region 61 (S1) corresponding to the speaker S1 shown in section A of FIG. 11 to start listening, the listening count is incremented to 1.

Next, if the user is unable to hear the speech and selects the upper speaker identification display region 61 (S1) again, the listening count becomes 2. In the case where the listening count threshold is set to 2, the target first character string “Hi, my name is nishi no daichi and”, is divided into “Hi, my name is” and “nishi no daichi and”, as shown in the upper character string display region 62 corresponding to the speaker S1 shown in section B in FIG. 11. In this case, when the listening count reaches 2, the listening count is reset, and the value is set to 0).

The first character string may be divided according to a pre-set number of characters, for example. Alternatively, positions corresponding to a clause or a phrase may be inferred, and the segment may be divided at the inferred positions. Alternatively, the division may be based on the confidence level. For example, the speech may be divided at a position between a high-confidence word and low-confidence word.

Furthermore, if the user continues listening and the listening count reaches 2 again, the target first character string “Hi, my name is” and “nishi no daichi and” is split into “Hi, my name is” and “nishi no” and “daichi and”, as shown in the upper character string display region 62 corresponding to the speaker S1 shown in section C of FIG. 11.

The attention image 130 includes the speaker identification display regions 61 (S1) and the character string display regions 62. In the example of section A in FIG. 11, the first character string “Hi, my name is nishi no daichi and” is displayed in the upper character string display region 62, and the first character string “address is Tokyo-to, Minato-ku, Shiba, 5-7-1. Thanks.” is displayed in the lower character string display region 62.

In the examples of sections B and C in FIG. 11, first character strings (one or more third character strings) and indications 131, 132, and 133 (vertical solid lines) indicating the division positions at which the first character strings were divided are displayed in the upper character string display region 62. Furthermore, a third character string may be highlighted, or the color, the pattern, or the like of the area surrounding a third character string may be changed.

### Apparatus Operation

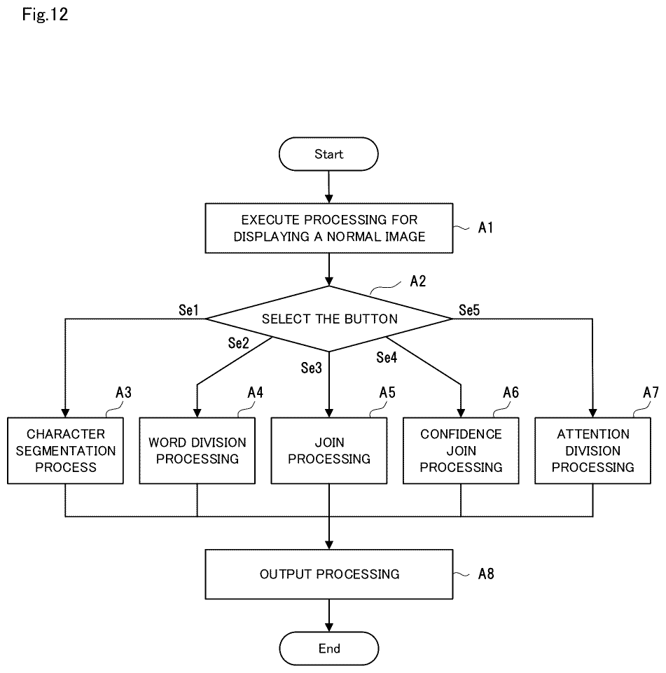

Next, operation of the hearing assistance apparatus according to the first example embodiment will be described below with reference to FIG. 12. FIG. 12 is a diagram illustrating an example of operation of the hearing assistance apparatus. The drawings will be referred to as appropriate in the following description. Also, in the first example embodiment, a hearing assistance method is carried out by causing the hearing assistance apparatus to operate. Therefore, the following description of operation of the hearing assistance apparatus will substitute for a description of the hearing assistance method according to the first example embodiment.

As shown in FIG. 12, the hearing assistance apparatus 10 executes processing for displaying a normal image (step A1). Specifically, the hearing assistance apparatus 10 executes the processing (normal processing) described in above section “(1) Normal image”.

Next, if the user selects the button 53 (character), the button 54 (word), the button 55 (join), the button 56 (confidence), or the button 57 (attention) displayed in the normal image (step A2: Se1, Se2, Se3, Se4, Se5), the hearing assistance apparatus 10 executes processing that corresponds to the selected button.

When the button 53 (character) is selected, the hearing assistance apparatus 10 executes processing for displaying a character image (step A3). Specifically, the hearing assistance apparatus 10 executes the processing (character segmentation process) described in above section “(2) Character image”.

If the button 54 (word) is selected, the hearing assistance apparatus 10 executes processing for displaying a word image (step A4). Specifically, the hearing assistance apparatus 10 executes the processing (word division processing) described in above section “(3) Character image”.

If the button 55 (join) is selected, the hearing assistance apparatus 10 executes processing for displaying a join image (step A5). Specifically, the hearing assistance apparatus 10 executes the processing (join processing) described in above sections (4-1) and (4-2) Join image.

If the button 56 (confidence) is selected, the hearing assistance apparatus 10 executes processing for displaying a confidence image (step A6). Specifically; the hearing assistance apparatus 10 executes the processing (confidence join processing) described in above section “(5) Confidence image”.

If the button 57 (attention) is selected, the hearing assistance apparatus 10 executes processing for displaying an attention image (step A7). Specifically, the hearing assistance apparatus 10 executes the processing (attention division processing) described in above section “(6) Attention image”.

The output device 40 acquires display information and speech output information from the hearing assistance apparatus 10 and performs output processing (step A8). For example, the display device 42 displays the various images described above. Moreover, the speech output device 41 outputs speech.

### Effects of First Example Embodiment

As described above, according to the first example embodiment, it is possible to present a desired portion of speech to the user when the user listens to speech, thus making it possible to reduce the listening time.

It is also possible to reduce the listening time when a user repeatedly listens to a segment (individual characters, individual words, or character string of various lengths).

### First Variation

In a first variation, the display information generation unit 13 generates highlighting information for highlighting one or more words (character strings) corresponding to speech output from the speech output device 41. The display information generation unit 13 outputs the generated display information to the display device 42.

Also, upon detecting a predetermined operation performed using the input device 30, the cursor movement unit 18 moves the cursor to a position immediately following one or more highlighted words (character strings).

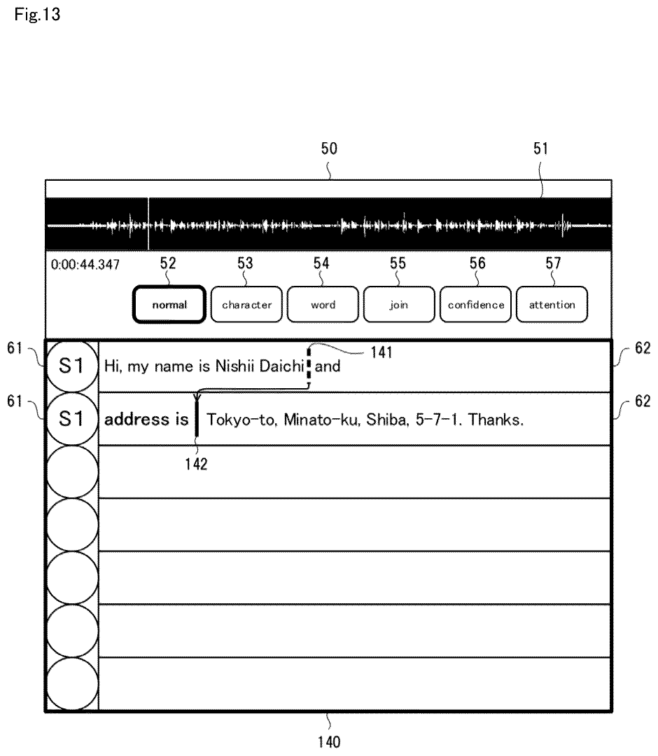

FIG. 13 is a diagram for describing the first variation. In the example of FIG. 13, a normal image 140 is displayed on the graphical user interface 50 used for hearing assistance.

The graphical user interface 50 in FIG. 13 displays the speech waveform display region 51, the button 52 (normal), the button 53 (character), the button 54 (word), the button 55 (join), the button 56 (confidence), the button 57 (attention), and the normal image 140, for example.

For example, in the case where the first character strings “my name is nishi no daichi and” and “address is Tokyo-to, Minato-ku, Shiba, 5-7-1” are displayed in character string display regions 62 corresponding to the speaker S1 shown in FIG. 13, if the user selects (e.g., clicks) a speaker identification display region 61 (S1) corresponding to the speaker S1 shown in FIG. 13, corresponding speech is output (reproduced)

The word (character string) that corresponds to the speech is then highlighted. In the example of FIG. 13, speech corresponding to the portion “address is” is being output, and thus “address is” is highlighted. In the example of FIG. 13, the corresponding characters are displayed at a larger size than the other characters.

Furthermore, if the hearing assistance apparatus 10 has an editing function (not shown), when performing tasks such as transcription for creating minutes of a meeting, and transcription based on speech, the user may desire to be able to quickly move the cursor to the portion that has been corrected.

In such a case, upon detecting a predetermined operation performed using the input device 30 (e.g., a pre-set shortcut key), the cursor movement unit 18 moves the cursor to a position immediately following one or more highlighted words (character strings).

In the example of FIG. 13, the user performs a predetermined operation using input device 30 while the cursor is at a position 141 (dashed line), speech corresponding to the portion “address is” is being output, and “the address is” is highlighted, and thus the cursor moves to a position 142 (vertical solid line).

In this way, according to the first variation, by moving the cursor, an incorrect word can be quickly corrected to the correct word.

### Program

The program according to the first example embodiment and the first variation may be a program that causes a computer to execute steps A1 to A8 shown in FIG. 12 and process of the first variation. By installing this program in a computer and executing the program, the hearing assistance apparatus and the hearing assistance method according to the first example embodiment and the first variation can be realized. In this case, the processor of the computer performs processing to function as the speech recognition information generation unit 11, the first division unit 12, the first joining unit 15, the second joining unit 16, the second division unit 17, the cursor movement unit 18, the display information generation unit 13, and the speech output information generation unit 14.

Also, the program according to the first example embodiment and the first variation may be executed by a computer system constructed by a plurality of computers. In this case, for example, each computer may function as any of the speech recognition information generation unit 11, the first division unit 12, the first joining unit 15, the second joining unit 16, the second division unit 17, the cursor movement unit 18, the display information generation unit 13, and the speech output information generation unit 14.

### Physical Configuration

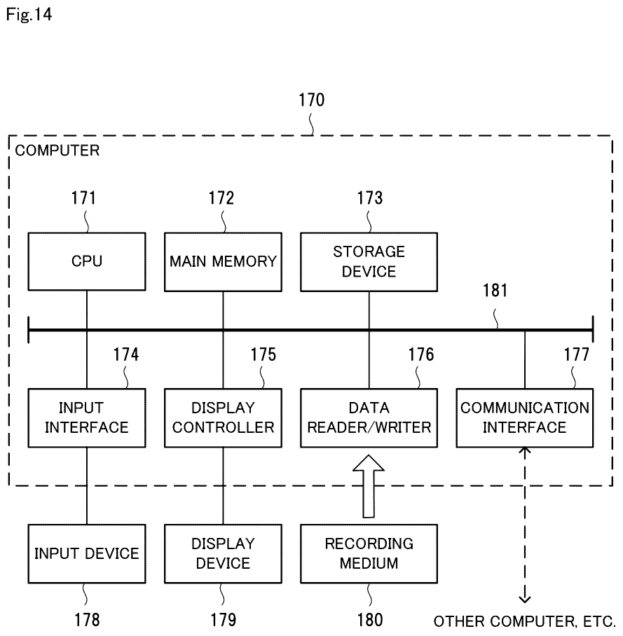

Here, a computer that realizes the hearing assistance apparatus by executing the program according to the first example embodiment and the first variation will be described with reference to FIG. 14. FIG. 14 is a block diagram showing an example of a computer that realizes the hearing assistance apparatus according to the first example embodiment and the first variation.

As shown in FIG. 14, a computer 170 includes a CPU (Central Processing Unit) 171, a main memory 172, a storage device 173, an input interface 174, a display controller 175, a data reader/writer 176, and a communications interface 177. These units are each connected so as to be capable of performing data communications with each other through a bus 181. Note that the computer 170 may include a GPU or an FPGA in addition to the CPU 171 or in place of the CPU 171.

The CPU 171 opens the program (code) according to the first example embodiment and the first variation, which has been stored in the storage device 173, in the main memory 172 and performs various operations by executing the program in a predetermined order. The main memory 172 is typically a volatile storage device such as a DRAM (Dynamic Random Access Memory). Also, the program according to the first example embodiment and the first variation is provided in a state being stored in a computer-readable recording medium 180. Note that the program according to the first example embodiment and the first variation may be distributed on the Internet, which is connected through the communications interface 177. Note that the computer-readable recording medium 180 is a non-volatile recording medium.

Also, other than a hard disk drive, a semiconductor storage device such as a flash memory can be given as a specific example of the storage device 173. The input interface 174 mediates data transmission between the CPU 171 and an input device 178, which may be a keyboard or mouse. The display controller 175 is connected to a display device 179, and controls display on the display device 179.

The data reader/writer 176 mediates data transmission between the CPU 171 and the recording medium 180, and executes reading of a program from the recording medium 180 and writing of processing results in the computer 170 to the recording medium 180. The communications interface 177 mediates data transmission between the CPU 171 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 180.

Also, instead of a computer in which a program is installed, the hearing assistance apparatus 10 according to the first example embodiment and the first variation can also be realized by using hardware corresponding to each unit. Furthermore, a portion of the hearing assistance apparatus 10 may be realized by a program, and the remaining portion realized by hardware.

Although the present invention of this application has been described with reference to exemplary embodiments, the present invention of this application is not limited to the above exemplary embodiments. Within the scope of the invention of this application, various changes that can be understood by those skilled in the art can be made to the configuration and details of the present invention of this application.

### INDUSTRIAL APPLICABILITY

As described above, it is possible to reduce the listening time by presenting a desired portion of speech to the user when the user listens to speech. In addition, it is useful in the field of the user listens to speech.

### LIST OF REFERENCE SIGNS

1 System
10 Hearing assistance apparatus
11 Speech recognition information generation unit
12 First division unit
13 Display information generation unit
14 Speech output information generation unit
15 First joining unit
16 Second joining unit
17 Second division unit
18 Cursor movement unit
20 Storage device
30 Input device
40 Output device
41 Speech output device
42 Display device
170 Computer
171 CPU
172 Main memory
173 Storage device
174 Input interface
175 Display controller
176 Data reader/writer
177 Communications interface
178 Input device
179 Display device
180 Recording medium
181 Bus

What is claimed is:

1. A hearing assistance apparatus comprising:
at least one memory storing instructions; and
at least one processor configured to execute the instructions to:
execute speech recognition processing on first speech information to infer one or more words from the first speech information, and generating speech recognition information by, for each of the one or more inferred words, associating word information representing the inferred word with second speech information corresponding to the inferred word;
divide a first character string formed by the one or more words into individual words or individual characters using the word information to generate second character string information representing a second character string; and
generate display information for displaying, on a display device, the second character string and a division position indicating a position at which the first character string was divided.

2. The hearing assistance apparatus according to claim 1,
wherein the one or more processors further:
in a case where a plurality of first character strings corresponding to speech uttered by the same speaker are displayed consecutively, joins the consecutive first character strings corresponding to the same speaker in order of utterance.

3. The hearing assistance apparatus according to claim 1,
wherein the one or more processors further:
detects a word associated with a confidence level greater than or equal to a pre-set confidence threshold in the first character string, and in a case where a plurality of detected words are consecutive, joining the consecutive detected words.

4. The hearing assistance apparatus according to claim 1, further comprising:
wherein the one or more processors further:
in a case where a listening count indicating how many times a user listened to speech corresponding to the first character string is a pre-set listening count threshold or more, dividing divides the first character string to generate a plurality of third character strings.

5. The hearing assistance apparatus according to claim 1,
wherein the one or more processors further:
generates highlighting information for highlighting one or more words corresponding to speech output from a speech output device.

6. The hearing assistance apparatus according to claim 5, further comprising:
wherein the one or more processors further:
in a case where a predetermined operation performed using an input device is detected, moving a cursor to a position immediately following the one or more highlighted words.

7. A hearing assistance method comprising causing a computer to carry out:
executing speech recognition processing on first speech information to infer one or more words from the first speech information, and generating speech recognition information by, for each of the one or more inferred words, associating word information representing the inferred word with second speech information corresponding to the inferred word;
dividing a first character string formed by the one or more words into individual words or individual characters using the word information to generate second character string information representing a second character string; and
generating display information for displaying, on a display device, the second character string and a division position indicating a position at which the first character string was divided.

8. A non-transitory computer readable recording medium for recording a program including instructions that cause a computer to:
executing speech recognition processing on first speech information to infer one or more words from the first speech information, and generating speech recognition information by, for each of the one or more inferred words, associating word information representing the inferred word with second speech information corresponding to the inferred word;
dividing a first character string formed by the one or more words into individual words or individual characters using the word information to generate second character string information representing a second character string; and
generating display information for displaying, on a display device, the second character string and a division position indicating a position at which the first character string was divided.

9. The hearing assistance method according to claim 7, further comprising
the computer, in a case where a plurality of first character strings corresponding to speech uttered by the same speaker are displayed consecutively, joining the consecutive first character strings corresponding to the same speaker in order of utterance.

10. The hearing assistance method according to claim 7, further comprising
the computer, detecting a word associated with a confidence level greater than or equal to a pre-set confidence threshold in the first character string, and in a case where a plurality of detected words are consecutive, joining the consecutive detected words.

11. The hearing assistance method according to claim 7, further comprising
the computer, in a case where a listening count indicating how many times a user listened to speech corresponding to the first character string is a pre-set listening count threshold or more, dividing the first character string to generate a plurality of third character strings.

12. The hearing assistance method according to claim 7,
wherein, generating highlighting information for highlighting one or more words corresponding to speech output from a speech output device.

13. The hearing assistance method according to claim 12, further comprising
the computer, in a case where a predetermined operation performed using an input device is detected, moving a cursor to a position immediately following the one or more highlighted words.

14. The non-transitory computer readable recording medium for recording a program according to claim 8 further including instructions that cause the computer to:
in a case where a plurality of first character strings corresponding to speech uttered by the same speaker are displayed consecutively, joining the consecutive first character strings corresponding to the same speaker in order of utterance.

15. The non-transitory computer readable recording medium for recording a program according to claim 8 further including instructions that cause the computer to:
detecting a word associated with a confidence level greater than or equal to a pre-set confidence threshold in the first character string, and in a case where a plurality of detected words are consecutive, joining the consecutive detected words.

16. The non-transitory computer readable recording medium for recording a program according to claim 8 further including instructions that cause the computer to:
in a case where a listening count indicating how many times a user listened to speech corresponding to the first character string is a pre-set listening count threshold or more, dividing the first character string to generate a plurality of third character strings.

17. The non-transitory computer readable recording medium for recording a program according to claim 8 further including instructions that cause the computer to:
generating highlighting information for highlighting one or more words corresponding to speech output from a speech output device.

18. The non-transitory computer readable recording medium for recording a program according to claim 8 further including instructions that cause the computer to:
in a case where a predetermined operation performed using an input device is detected, moving a cursor to a position immediately following the one or more highlighted words.
